(19) United States
(12) Patent Application Publication
(10) Pub. No.: US 2005/0235202 A1
(43) Pub. Date: Oct. 20, 2005

(54) Automatic graphical layout printing system utilizing parsing and merging of data

(76) Inventors: Tsu-Wang Chen, Fremont, CA (US); Ting-Hu Wu, Fremont, CA (US); Chaur G. Wu, Dublin, CA (US)

Correspondence Address: Dergosits & Noah LLP, Suite 1450, Four Embarcadero Center, San Francisco, CA, 94111, US

(21) Appl. No.: 10/828,489

(22) Filed: Apr. 20, 2004

(51) Int. Cl. G06F 17/24; G06F 17/21

(52) U.S. Cl. 715/523

(57) ABSTRACT

An automatic graphical layout printing system is described. In a distributed client server computer network, a print generation system is employed to convert documents and data objects generated and managed in various different formats into a generic electronic form format for print output. The print generation system imports form and content data comprising a document or similar data object. The graphical layout information and content data are extracted from the document to produce a stripped document. Metadata comprising rules that define the data field coordinate and type information within the document is generated from the graphical layout information and content data. New content data to be included in the document is then merged with the stripped document and metadata. A printable document consisting of the merged stripped document, metadata and content data is then generated.

### FIELD OF THE INVENTION

The present invention relates generally to data processing, and more specifically, to an automatic print generation system that merges form layout data with content data to provide final documents.

### BACKGROUND OF THE INVENTION

The on-line implementation of many data processing systems has allowed users to fill-out various forms directly on their computer. Whereas early implementations of computerized data entry systems provided rudimentary user interfaces for data input, present systems often provide data input screens that appear identical to the actual paper forms that a user would fill-out if submitting a form in person or by mail. For example, various government agencies, such as the Social Security Administration now provide on-line form processing capabilities so that users can fill out electronic versions of forms, such as applications for Social Security cards, and submit them over a computer network. The computerized forms are identical in appearance to the paper forms that are traditionally used so that users do not need to receive special instructions regarding the format and data entry requirements of the on-line version of the form.

The adaptation of on-line forms to a format that is familiar to users has greatly enhanced the usability and efficiency of many on-line data processing systems. However, such systems require the on-line forms to be laid out in a pre-defined design that may not be optimized for computerized data entry. Furthermore, the management of content data within the on-line forms often requires additional processing overhead because of possible layout constraints and fixed graphical information and data type definitions. This can make defining new forms or adapting content data to other on-line forms or printable documents a costly process.

Various different systems have been developed to create and manage on-line forms using electronic form software based on word-processing, database, and/or desktop publishing applications. For example, U.S. Pat. No. 5,091,868 entitled “Method and Apparatus for Forms Generation,” describes a system in which a central workstation is used to design and prepare a form that is provided as an object code output program to remote workstations to generate the form. Other systems have expanded this idea to allow that ability of form layouts and definitions to be transferred among different computer platforms. These systems, however, typically provide only a means to convert a generic form or a completed form with form definition and data from one format to another. Such systems do not provide a means to merge form layout data with data field information and content data into a populated form that is formatted for print output. Moreover, because these systems typically operate on digitized graphic data and user input content data, they usually require a great deal of storage and processing resources.

What is needed, therefore, is a electronic form generation and printing system that defines the design and definition of a form so that content data can be dynamically merged to produce a completed form suitable for printing.

What is further needed is a print generation system for a distributed network that can efficiently and quickly deconstruct form definitions and reconstruct printable form documents from the form definition data and content data.

### SUMMARY OF THE INVENTION

An automatic graphical layout printing system for providing dynamic generation of populated electronic forms is described. In one embodiment of the present invention, a print generation system is employed in a distributed client server computer network to convert documents and data objects generated and managed in various different formats into a generic electronic form format for print output. The print generation system imports form and sample content data comprising a document or similar data object. The content data is extracted from the document to produce a stripped document along with metadata for the content data. The metadata defines the data field coordinates and data type information. The stripped document defines the graphical layout information for the document. New content data from a database or data store is merged with the stripped document based on the specifications set forth in the metadata. A printable document consisting of the merged stripped document and new content data is then generated. In one embodiment, the print output system employs the Portable Document Format (PDF) protocol to generate the final printable document.

Other objects, features, and advantages of the present invention will be apparent from the accompanying drawings and from the detailed description that follows below.

### BRIEF DESCRIPTION OF THE DRAWINGS

The present invention is illustrated by way of example and not limitation in the figures of the accompanying drawings, in which like references indicate similar elements, and in which:

FIG. 1 is a block diagram of a network for implementing an automatic graphical layout printing system, according to one embodiment of the present invention;

FIG. 2A is a flowchart that illustrates the steps of automatically producing a printable electronic form, according to a method of the present invention;

FIG. 2B graphically illustrates the data extraction and merging functions for the print generation process illustrated in FIG. 2A; and

FIG. 3 is a block diagram illustrating an automatic graphical layout printing system, according to one embodiment of the present invention.

### DETAILED DESCRIPTION OF THE PREFERRED EMBODIMENT

An automatic graphical layout printing system for the generation and printing of electronic forms is described. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of preferred embodiments is not intended to limit the scope of the claims appended hereto.

Aspects of the present invention may be implemented on one or more computers executing software instructions. According to one embodiment of the present invention, server and client computer systems transmit and receive data over a computer network or a fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers. In some instances, the client and server functionality may be implemented on a single computer platform.

Aspects of the present invention can be used in a distributed electronic commerce application that includes a client/server network system that links one or more server computers to one or more client computers, as well as server computers to other server computers and client computers to other client computers. The client and server computers may be implemented as desktop personal computers, workstation computers, mobile computers, portable computing devices, personal digital assistant (PDA) devices, or any other similar type of computing device.

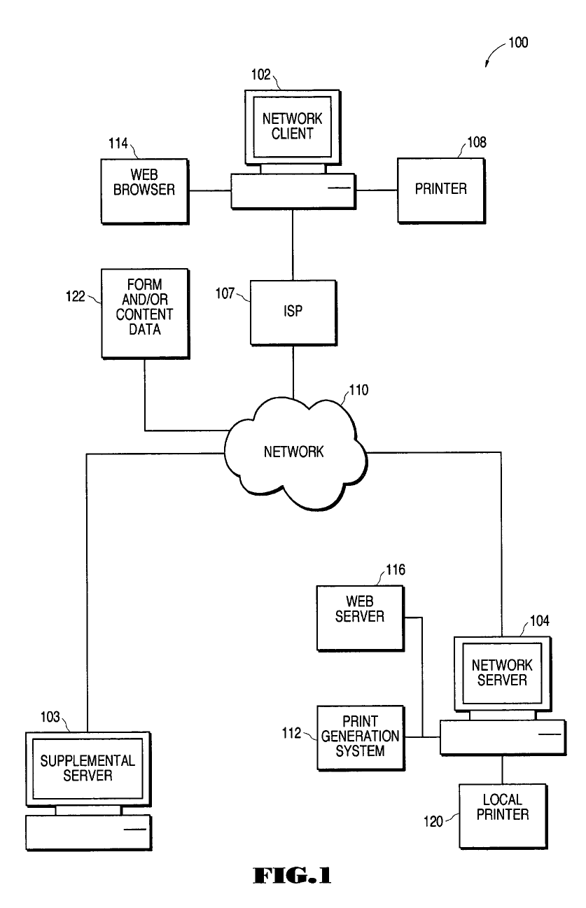

FIG. 1 illustrates an exemplary network system that includes distributed client/server computers that includes a print generation system for processing and producing electronic forms or documents that might be stored or generated in various different formats. In the network embodiment illustrated in FIG. 1, the server computer 104 executes a print generation process 112. This process includes an electronic form print process that formats and transmits on-line data for final output or printing. The document to be produced may be printed on a local printer 120, also coupled to server computer 104, or a remote printer 108 coupled to a network client computer 102. The print generation system 112 takes as input forms or documents that content data 122. These documents can be in any type of format, such as word processing documents, database data, spreadsheet data, CAD drawings, or digitized image data from scanned documents, and so on. The forms and content data 122 can reside on the network client 102, on the server computer 104, or on another network resource, such as supplemental server 103. The print generation system 112 then generates compact output forms for print output on a printer 120.

In one embodiment of the present invention, the electronic form output process of the print generation system 112 converts the form or content data 122 into compact, multi-page PDF (Portable Document Format) files as output. The PDF file format, created by Adobe® Corp., was developed to provide a standard form for storing and editing printed publishable documents. Documents in .pdf format are generally easy to view and print on a variety of computer and platform types, and have become very common on the World Wide Web. To view files of this type, client computers run a reader program, such as Adobe Acrobat Reader. Using such a program, PDF files can usually be read by any computer (Macintosh, Windows or UNIX) without platform conflicts. PDF files can be distributed over networks, such as on the World Wide Web, or through physical media, such as diskette or CD-ROM, or can be directly printed from a computer. A PDF file retains the formatting created for the page including fonts and graphics. Thus, PDF is a file format that represents documents in a manner that is independent of the original application software, hardware, and operating system used to create those documents. A PDF file can describe documents containing any combination of text, graphics, and images in a device-independent and resolution independent format.

For a network embodiment in which the client and server computers communicate over the World Wide Web portion of the Internet, the client computer 102 typically accesses the network through an Internet Service Provider (ISP) 107 and executes a web browser program 114 to display web content through web pages. In one embodiment, the web browser program is implemented using Microsoft® Internet Explorer™ browser software, but other similar web browsers may also be used. Network 110 couples the client computer 102 to server computer 104, which executes a web server process 116 that serves web content in the form of web pages to the client computer. In addition, the system 100 may also include other networked servers, such as supplemental server 103.

In general, files, documents, drawings or any other type of data object generated, managed, and printed by the network system consist of information that defines the appearance of the document, and data that comprises the content of the document. The information that defines the appearance of the document generally consists of layout information that defines where the content data is located and how it is formatted. For example, an on-line calendar can consist of data entry fields defining days of the month in a particular graphical format that allows a user to input meeting or appointment information. The field definitions and their layout comprise the document data (i.e., data type definitions and graphical layout definitions), while the actual meeting or appointment information entered by the user comprises the content data. A completed on-line form thus comprises various different data types and data.

In one embodiment of the present invention, the print generation system 112 consists of sub-processes that deconstructs the data within a completed on-line form to produce a stripped form and merge new data into the stripped form to produce a new printable document. The print generation system includes an automatic coordination extraction system that parses out the information specifying the location of content data within the document, and a data mapping script engine that performs any script or program processing on the content data and puts the data in the appropriate locations of the stripped document. A graphical layout process then compiles the extracted format data with the processed data to produce a printable final document.

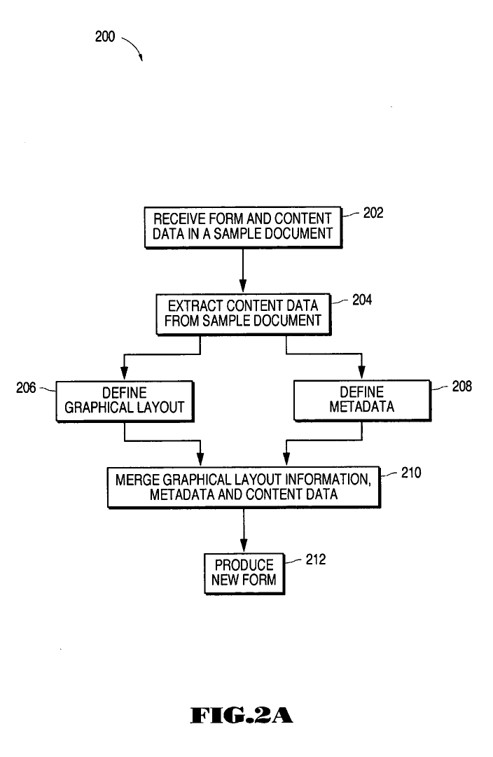

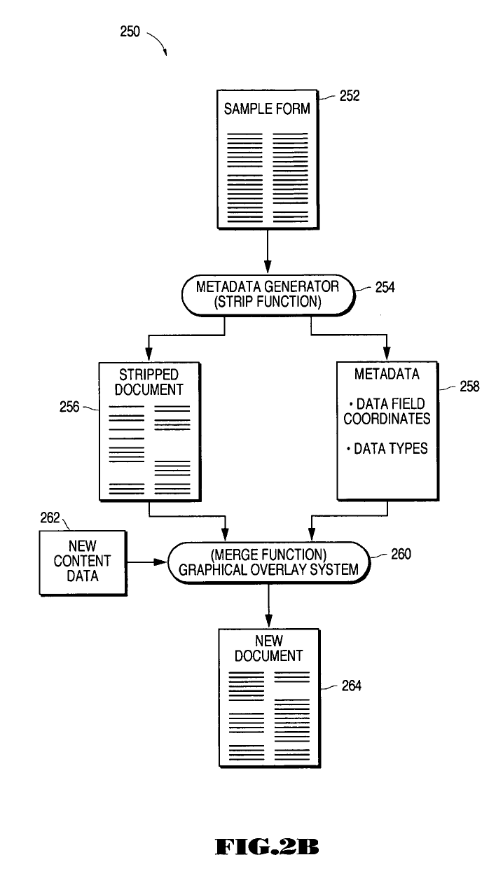

FIG. 2A is a flowchart that illustrates the basic processes executed by a print generation system 112 of FIG. 1, according to one embodiment of the present invention. As illustrated in flowchart 200, in step 202, the system receives the form and content data in a document, such as an on-line form that is filled with sample content data. Such form and content data is also referred to as “raw” data. This can consist of a document or file produced by an application program, or it can be digitized data representing the electronic version of a physical document.

Typical on-line or electronic form or template-based documents comprise both graphical layout information and the actual content data. The content data may include different types of data, such as numbers, names, etc., and may be placed in specific places in the document. The data types and field locations for the document must therefore be defined. These definitions are referred to as “metadata” and represent information regarding the content data. In step 204, the content data is extracted from the document. This is typically performed by separating the metadata from the content data actually input in the data fields. If the content data is of no use, it may be discarded. In some cases, though it may be saved for later use or archive purposes. This extraction step 204 leaves a stripped form or document that contains the graphical layout information of the document. This graphical layout information consists of information such as form design and size, typeface and image appearance definitions (e.g., colors, fonts, and styles), and other similar layout information. The graphical layout information is parsed out and defined in step 206. The extraction step 204 also generates the metadata, which comprises rules or definitions regarding data types and the location of the data fields within the form (data field coordinates). The metadata is parsed out and defined in step 208.

Once the graphical layout and metadata for the stripped form is extracted, the form can be populated with new content data. This content data can be input from any source, such as a database or direct data entry by the user. In step 210, new content data is merged with the graphical layout information and the metadata. This produces a new populated form that can be printed or passed on for further processing, step 212.

FIG. 2B graphically illustrates the data extraction and merging functions for the print generation process illustrated in FIG. 2A. As illustrated in flow diagram 250, a sample form 252, which consists of an on-line form populated with sample data is input into a metadata generator process 254. The metadata generator provides a “stripping function” that essentially extracts the content data from the sample form 252 to produce a stripped document 256 and metadata 258. The stripped document contains the layout of the document or form, and the metadata defines the rules concerning the type and location of the content data within the form.

A graphical overlay system 260 provides the merge function that merges the stripped document 256 and metadata 258 with new content 262. The new content is placed in the document according to rules defined by the metadata; that is, data of a specific type is placed in a particular place within the document according to the metadata rules. The layout and appearance of the merged document is dictated by the graphical layout information defined by the stripped document 256. The merge function 264 thus produces a new printable document 264.

In one embodiment of the present invention, the metadata generator process 254 and the graphical overlay system process 260 illustrated in flow diagram 250 are functional subprocesses executed within the print generation system 112 of FIG. 1.

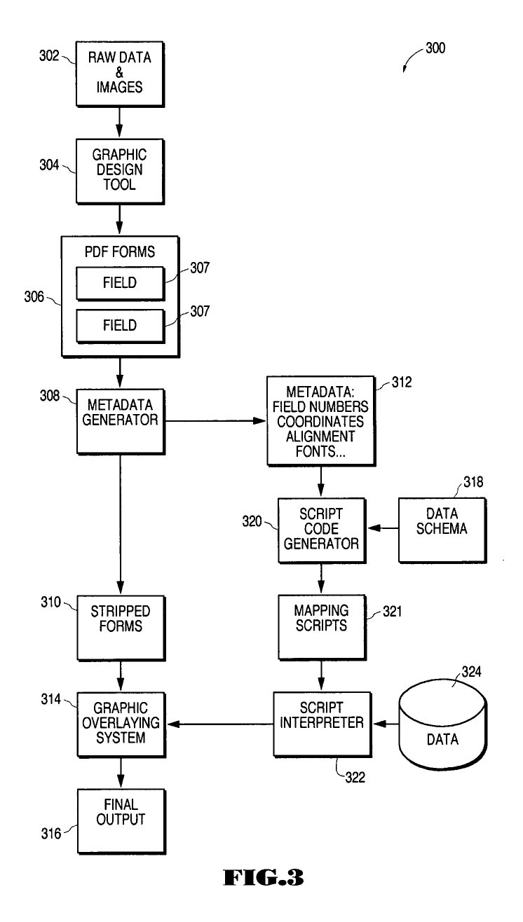

FIG. 3 is a block diagram illustrating the functional components of the print generation system executed by network 100, according to one embodiment of the present invention. As a first step, raw data/images 302 are input to the system. This data corresponds to the form/content data 122 in FIG. 1, and represents content data within a document, image, or data structure, as well as any required formatting or imaging data that is used by the system to generate the print output. This data can also be provided in the form of an on-line form that is populated with sample content. The raw data can come from various different sources and applications, such as different client computers within network 100 or different application programs executed by the computers. Typical programs that are used to generate such data include word processors, database programs, spreadsheet programs, drawing programs, computer-aided drafting (CAD) programs, and so on. The raw data may also be electronic versions of physical documents, such as those produced by scanning or digitizing processes.

A graphic design tool 304 is used to preprocess the raw data/image input 302. This tool transforms the raw data into PDF files. The data is arranged in fields 307 within a PDF form file 306. This step generates a PDF form that is used to organize and present the data in a pre-defined form style. In general, PDF files contain field definitions that dictate the type of data in each field and the location of the fields on the page. In some cases the data field types and locations may be automatically provided within the PDF document. In other cases, a separate editor may be required to define the location and type of each data field.

After form designers finish the design of PDF forms, the forms are passed to metadata generator 308, which generates two different output files from the PDF form. These output files comprise a stripped form file 310 and a metadata file 312. The stripped form file 310 contains static information that is included in the final output product (such as page size, orientation, borders, and so on). The metadata files 312 contain metadata of dynamic information in the final output product. Such dynamic information includes information that defines the layout and appearance of the print output, such as, field names, field coordinates, font, font size, alignment, graphic type, and so on.

Separating the static and dynamic information at this early stage of the form output generation process optimizes the speed of processing and allows efficient use of memory resources. In general, PDF forms generated by the graphic design tool can be quite large in terms of file size. By stripping form field definitions, which are the dynamic portion of the output document, the file size can be significantly reduced, such as by a factor of ten. This represents a significant savings in memory and disk space utilized. In terms of processing time, significant performance gains can be achieved since form field definitions are separated out, thus leaving the stripped forms intact allowing processing only on the dynamic portion of our final printed document. In this manner, PDF files objects that are permanently defined (i.e., those that will not change) do not need to be loaded into the system.

For the embodiment illustrated in FIG. 3, the mapping from backend (raw) data to front-end data residing in PDF fields is automated by a script management sub-process. A script code generator 320 stores the information related to location information regarding where to pull information from backend data source, any arithmetic and logical operations to perform on the extracted information, and where to put the calculated results in PDF forms. Other scripts, or subprograms that manipulate the content, format, mapping, or otherwise modify the data before or after insertion into the PDF form can also be stored in the script code generator 320. The script code generator 320 generally takes as inputs the metadata 312 that defines the appearance of the data, and the data schema 318 that defines the location of the data.

The information regarding where to pull the data, the processing or format of the data, and where to put the data in the PDF form is stored by the script code generator in one or more mapping scripts 321. The mapping scripts 321 are interpreted by a script interpreter 322. A graphic overlaying system 314 takes the output of the script interpreter 322 and the stripped form information 310, and field metadata 312 to generate a printable output document. The graphic overlaying system 314 overlays the stripped forms 310 with data generated by script interpreter 322 in appropriate appearance and format. The content data that is input into the final output document is represented as data 324. This data can be stored and retrieved for input into system 300 from a variety of sources. The final printable output 316 that is generated by the graphic overlaying system 314 is then suitable for printing to an output device, such as local printer 120.

The automatic graphical layout printing system illustrated in FIG. 3 can be embodied in the print generation system 112 of FIG. 1. In this context, the network server 104 can receive data 122 from various different client computers 102 that may be generated or stored in various different file formats. The data is then processed into printable forms that can be output to any networked printers. The use of web-based interfaces allows the form documents to be transmitted, displayed, and output in the form of familiar PDF documents. The automatic graphical layout system 300 allows the document data and format information to be processed in a fast and efficient manner with respect to memory resources and processing overhead.

The print generation system can be used to generate generic on-line forms from existing forms, and then populate generic forms with new data. It can also be used to convert or define generic forms across different platforms, or modify the format of existing forms. The newly generated forms can then be populated and output to a printer.

Although specific embodiments of the present invention were described with reference to PDF file format documents and forms, it should be understood that other portable data file formats can also be used in conjunction with embodiments of the present invention.

In the foregoing, a system has been described for an automatic graphic layout printing system. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

1. A computer-implemented method for producing a printable document in platform-independent format, the method comprising:
importing form and content data comprising a document into a print generation process;
extracting graphical layout information and content data from the document to produce a stripped document;
defining metadata specifying data types and data field coordinates from the graphical layout information and the content data;
merging the stripped document with the metadata and new content data to produce a new document consisting of the new content data in a format consistent with the imported document.

2. The method of claim 1 wherein the document comprises a form consisting of pre-defined fields, with each field of the pre-defined field containing a unique portion of content data.

3. The method of claim 2 wherein the metadata comprises rules defining coordinate location and appearance information for each of the pre-defined fields.

4. The method of claim 1 further comprising the step of processing the content data in a script interpreter subprocess prior to merging the content data with the stripped document and metadata.

5. The method of claim 4 wherein the content data is stored in a memory storage coupled to a computer importing the form and content data.

6. A computer-implemented method for producing a printable document in platform-independent format, the method comprising:
receiving a pre-defined document consisting of graphical layout information and sample content data;
defining metadata rules from the pre-defined document that dictate data types and data field locations within the pre-defined document;
extracting the sample content data from the pre-defined document to produce a stripped document containing graphical layout information; and
merging the stripped document with the metadata rules and new content data to produce a new document consisting of the new content data in a format consistent with the predefined document.

7. The method of claim 6 wherein the pre-defined document comprises a form consisting of pre-defined fields, with each field of the pre-defined field containing a unique portion of content data.

8. The method of claim 7 wherein the metadata comprises rules defining coordinate location and appearance information for each of the pre-defined fields.

9. The method of claim 6 further comprising the step of processing the content data in a script interpreter subprocess prior to merging the content data with the stripped document and metadata rules.

10. The method of claim 9 wherein the content data is stored in a memory storage coupled to a computer importing the form and content data.

11. The method of claim 6 further comprising the steps of:
converting the pre-defined document to a PDF document; and
defining the metadata within the converted PDF document.

12. A system for producing a printable document in platform-independent format, comprising:
an input process configured to receive a pre-defined document consisting of graphical layout information and sample content data;
a metadata generator configured to derive metadata rules from the pre-defined document that dictate data types and data field locations within the pre-defined document;
an extraction process configured to extract the sample content data from the pre-defined document to produce a stripped document containing graphical layout information; and
a merge process configured to merge the stripped document with the metadata rules and new content data to produce a new document consisting of the new content data in a format consistent with the predefined document.

13. The system of claim 12 wherein the pre-defined document comprises a form consisting of pre-defined fields, with each field of the pre-defined field containing a unique portion of content data.

14. The system of claim 13 wherein the metadata comprises rules defining coordinate location and appearance information for each of the pre-defined fields.

15. The system of claim 15 further comprising a script interpreter subprocess configured to process the content data prior to merging the content data with the stripped document and metadata rules.

16. The system of claim 12 further comprising a memory storage storing the content data.

17. The system of claim 16 wherein the input process is executed on a server computer coupled to a client computer over a network, and wherein the memory storage is coupled to the network.

18. The system of claim 18 wherein the network comprises the World Wide Web portion of the Internet, and wherein the printable document comprises a PDF document.

19. The system of claim 16 further comprising a printing device coupled to the network and configured to print the new document.
